(19) United States
(12) Patent Application Publication
(10) Pub. No.: US 2008/0019798 A1
(43) Pub. Date: Jan. 24, 2008

(54) Nail with a reinforcement section

(75) Inventor: Yi-Kuan Lee, Ta-Li City (TW)

Correspondence Address: CHARLES E. BAXLEY, ESQ., 90 JOHN STREET, THIRD FLOOR, NEW YORK, NY, 10038, US

(73) Assignee: Samson Power Tool Co., Ltd.

(21) Appl. No.: 11/821,324

(22) Filed: Jun. 22, 2007

(30) Foreign Application Priority Data
Jul. 24, 2006 (TW) 095213018

(51) Int. Cl. F16B 15/00

(52) U.S. Cl. 411/487

(57) ABSTRACT

A nail includes a head and a shank which extends from an underside of the head and includes a reinforcement section a shank body. A tip portion is formed on a distal end of the shank body and the reinforcement section is connected between the head and the shank body. A diameter of the reinforcement section is larger than a diameter of the shank body.

### FIELD OF THE INVENTION

The present invention relates to a nail with a reinforcement section connected between the head and the shank of the nail.

### BACKGROUND OF THE INVENTION

A conventional nail 1 used with pneumatic nailers is shown in FIG. 1 and generally includes head 10, a shank 11 extending from an underside of the head 10 and a tip 13 located at a distal end of the shank 11. The shank 11 has a consistent diameter. The nails 1 are sent into the nose of a pneumatic nailer one by one and the each nail 1 is ejected by a piston rod when the user pulls the trigger of the nailer. As shown in FIG. 2, the nail 1 is to be nail a metal board 2 on a wood block 3, and the metal board 2 includes a hole 20. The user aims the nail 1 and then pulls the trigger to insert the nail into the wood block 3 via the hole 20. However, the metal board 2 usually shifts by vibration relative to the wood block 3 when the nail 1 is inserted into the wood block 3. It is noted that there is a wide gap between the shank 11 and an inner periphery of the hole 20. The shift generates a shear force which might cut the shank 11. In order to solve this problem, the user can use a larger-sized nail used with the nailer and the shank of the larger-sized nail has a larger diameter so that the shank does not cut by the shear force. Nevertheless, the larger-sized nails have to be cooperated with a larger-sized nailer which is heavy and bulky.

The present invention intends to provide a nail for pneumatic nailer and a reinforcement section is connected between the head and the shank, the shank reinforces the structural strength of the shank so as to solve the problem mentioned above.

### SUMMARY OF THE INVENTION

The present invention relates to a nail which comprises a head and a shank extends from an underside of the head. The shank includes a reinforcement section a shank body. A tip portion is formed on a distal end of the shank body and the reinforcement section is connected between the head and the shank body. A diameter of the reinforcement section is larger than a diameter of the shank body.

The primary object of the present invention is to provide a nail which includes a reinforcement section between the shank body and the head of the nail. The reinforcement section increases the strength of the shank so as to bear the shear force when nailing into the object.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view to show that one of the conventional nails aims the hole of the metal board on a wood block;

FIG. 2 is a cross sectional view to show that the conventional nail nails into the wood block via the hole of the metal board;

FIG. 3 shows the side view and the bottom view of the nail of the present invention;

FIG. 4 FIG. 1 is a cross sectional view to show that one of the nails of the present invention aims the hole of the metal board on a wood block, and

FIG. 5 is a cross sectional view to show that the nail of the present invention nails into the wood block via the hole of the metal board.

### DETAILED DESCRIPTION OF THE PREFERRED EMBODIMENT

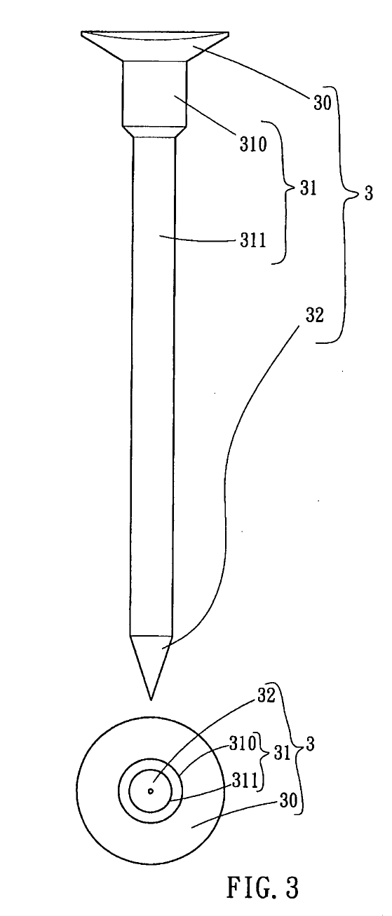

Referring to FIG. 3, the nail 3 of the present invention comprises a head 30 and a shank 31 which extends from an underside of the head 30. The shank 31 includes a reinforcement section 310 a shank body 311. A cone-shaped tip portion 32 is formed on a distal end of the shank body 310 and the reinforcement section 310 is connected between the head 30 and the shank body 311. A diameter of the reinforcement section 310 is larger than a diameter of the shank body 311, and a diameter of the reinforcement section 310 is smaller than a diameter of the head 30. The tip portion 310 can also be different shapes such as wedge-shaped tip portion or rhombic cone tip portion.

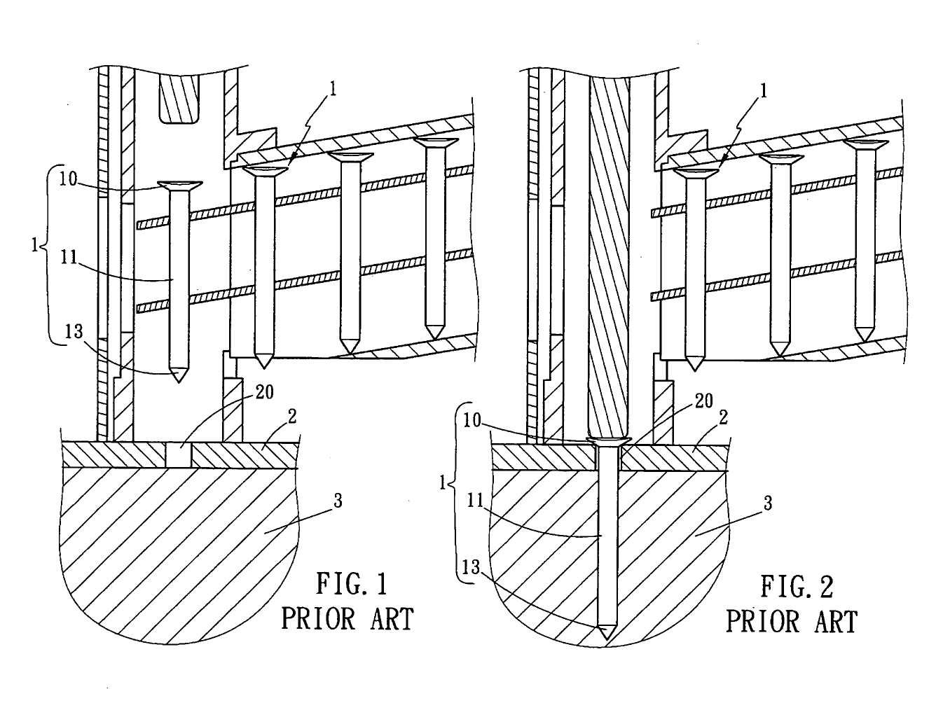

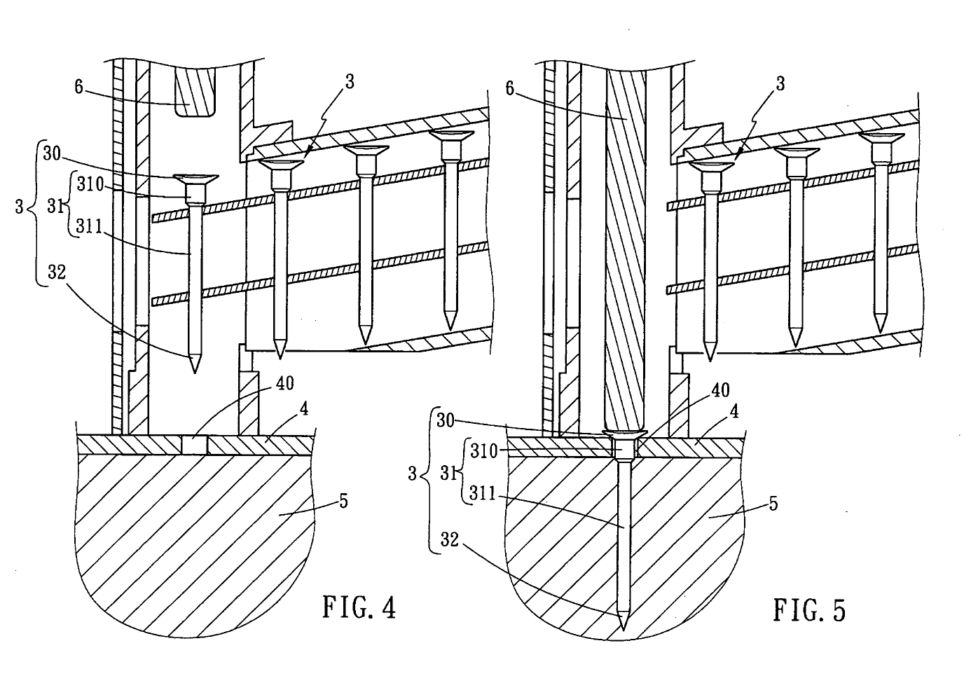

As shown in FIGS. 4 and 5, the nails 3 are sent into the nose of the pneumatic nailer one by one and the nail 3 aims the hole 40 in the metal board 4 which is located on a wood block 5. The nail 3 is pushed by the piston rod 6 when the user pulls the trigger of the nailer. As shown in FIG. 5, the nail 3 nails into the wood block 5 via the hole 40. It is noted that the reinforcement section 310 fills the hole 40 so that even if the metal board 4 shifts, the reinforcement section 310 is strong enough to bear the shear force. Besides, only a small gap is formed between the reinforcement section 310 and the inner periphery of the hole 40 so that the metal board 4 only shifts a little bit and the shear force is much less than the shear force applied to the conventional nail 1 as described in FIGS. 1 and 2.

While we have shown and described the embodiment in accordance with the present invention, it should be clear to those skilled in the art that further embodiments may be made without departing from the scope of the present invention.

What is claimed is:

1. A nail 3 comprising:
a head 30 and a shank 31 which extends from an underside of the head 30, the shank 31 including a reinforcement section 310 a shank body 311, a tip portion 32 formed on a distal end of the shank body 310 and the reinforcement section 310 connected between the head 30 and the shank body 311, a diameter of the reinforcement section 310 being larger than a diameter of the shank body 311.

2. The nail as claimed in claim 1, wherein the tip portion 32 is a cone-shaped portion 32.

3. The nail as claimed in claim 1, wherein a diameter of the reinforcement section 310 is smaller than a diameter of the head 30.
